(19) United States
(12) Patent Application Publication
(10) Pub. No.: US 2019/0243137 A1
(43) Pub. Date: Aug. 8, 2019

(54) LAMINATED GLASS

(71) Applicant: AGC Inc., Tokyo (JP)

(72) Inventors: Shunsuke SADAKANE, Tokyo (JP); Tokihiko AOKI, Tokyo (JP)

(73) Assignee: AGC Inc., Tokyo (JP)

(21) Appl. No.: 16/388,264

(22) Filed: Apr. 18, 2019

Related U.S. Application Data
(63) Continuation of application No. PCT/JP2017/036449, filed on Oct. 6, 2017.

(30) Foreign Application Priority Data
Oct. 26, 2016 (JP) 2016-210009

(51) Int. Cl. G02B 27/01; B32B 17/10; B32B 7/12; B32B 3/26

(52) U.S. Cl. CPC G02B 27/0101; B32B 17/10568; B32B 17/10036; B32B 2551/00; B32B 7/12; B32B 3/263; G02B 2027/011; B32B 17/10761

(57) ABSTRACT

A laminated glass includes a first glass sheet; a second glass sheet; and an interlayer positioned between the first and second glass sheets, to bond these glass sheets together; a first area, a transition area, and a second area are provided from a lower side of the laminated glass when attached to a vehicle; the first area is used for a head-up display, whereas the transition area and the second area are not; the first area is thicker at an upper end side than at lower end side, to have a wedge shape in cross section forming a positive wedge angle; the second area is thinner at an upper end side than at lower end side, to have a wedge shape in cross section forming a negative wedge angle; and the transition area is an area where the positive wedge angle transitions to the negative wedge angle.

### CROSS-REFERENCE TO RELATED APPLICATIONS

This U.S. non-provisional application is a continuation application of, and claims the benefit of priority under 35 U.S.C. § 365(c) from, PCT International Application PCT/JP2017/036449 filed on Oct. 6, 2017, which is designated the U.S., and is based upon and claims the benefit of priority of Japanese Patent Application No. 2016-210009 filed on Oct. 26, 2016, the entire contents both of which are incorporated herein by reference.

### TECHNICAL FIELD

The present disclosure relates to laminated glass.

### BACKGROUND ART

In recent years, introduction of head-up displays (also referred to as “HUD”, below) has made progress, with which predetermined information is displayed in the field of vision of the driver of a vehicle, by reflecting images on the windshield of the vehicle. However, there may be cases where double images pose a problem when the driver is visually recognizing an outside scene or information displayed by the HUD.

Double images that pose problems for the driver of a vehicle may be categorized as a transmitted double image or as a reflected double image. If the windshield has an HUD-display area used by the HUD, and a non-HUD-display area (a transparent area) not used by the HUD, a transmitted double image may become a problem in the HUD-display area although a reflected double image is the main problem, and in the non-HUD-display area, a transmitted double image is the problem.

It has been known that such reflected double images or transmitted double images can be reduced by using a laminated glass for the windshield that has a wedge shape in cross section when viewed in the horizontal direction. For example, a technique has been proposed in which an interlayer is sandwiched between two glass sheets and the wedge angle of the interlayer is changed depending on the location of the windshield (laminated glass) (see, for example, Japanese Unexamined Patent Application Publication No. 2014-024752).

Meanwhile, even for the same type of vehicle, there are cases where two types of windshields exist; a windshield for HUD having a wedge-shaped area in cross-sectional view, and a windshield not having a wedge-shaped area in cross-sectional view (not used for HUD). In these two types of windshields, the thickness at the upper end differs significantly. When the thickness at the upper end of the windshield differs significantly depending on the presence or absence of the wedge-shaped area in cross-sectional view, two types of attachment parts used for attaching the windshield to the vehicle frame are required, which leads to an increase of cost. Also, when the windshield is assembled to the vehicle frame, a step is formed on the upper end of the windshield and the vehicle frame, which is not preferable from the viewpoint of design.

### SUMMARY

According to an embodiment, a laminated glass includes a first glass sheet; a second glass sheet; and an interlayer positioned between the first glass sheet and the second glass sheet, to bond the first glass sheet and the second glass sheet together; a first area, a transition area, and a second area are provided from a lower side of the laminated glass when the laminated glass is attached to a vehicle; the first area is used for a head-up display, and the transition area and the second area are not used for the head-up display; the first area has a thickness at an upper end side thicker than at lower end side when the laminated glass is attached to the vehicle, to have a wedge-shaped cross-sectional shape forming a positive wedge angle; the second area has a thickness at an upper end side thinner than at lower end side when the laminated glass is attached to the vehicle, to have a wedge-shaped cross-sectional shape forming a negative wedge angle; and the transition area is an area in which the positive wedge angle transitions to the negative wedge angle, which are requirements.

### BRIEF DESCRIPTION OF DRAWINGS

FIGS. 1A-1B are diagrams illustrating concepts of double images;

FIGS. 2A-2B are diagrams illustrating a windshield for a vehicle;

FIG. 3 is a partial cross-sectional view of the windshield 20 illustrated in FIG. 2 sectioned in the XZ direction and viewed in the Y direction;

FIG. 4 is a diagram illustrating an example of wedge angle sizes of a first area Rₐ, a transition area R_{b}, and a second area R_{c}; and

FIG. 5 is a diagram illustrating design examples (application examples and comparative examples) of wedge angles.

### EMBODIMENTS OF THE INVENTION

In the following, embodiments will be described with reference to the drawings.

According to the disclosed technique, it is possible to prevent an increase of the thickness at the upper end of the laminated glass while preventing an increase of double images in a laminated glass having an area used for a head-up display.

Throughout the drawings, the same elements are assigned the same reference symbols, and duplicated description may be omitted. Note that although a windshield for a vehicle will be taken as an example for the description here, the application is not limited as such; the glass according to the embodiments can be applied to glass other than windshields for vehicles.

[Reflected Double Image and Transmitted Double Image]

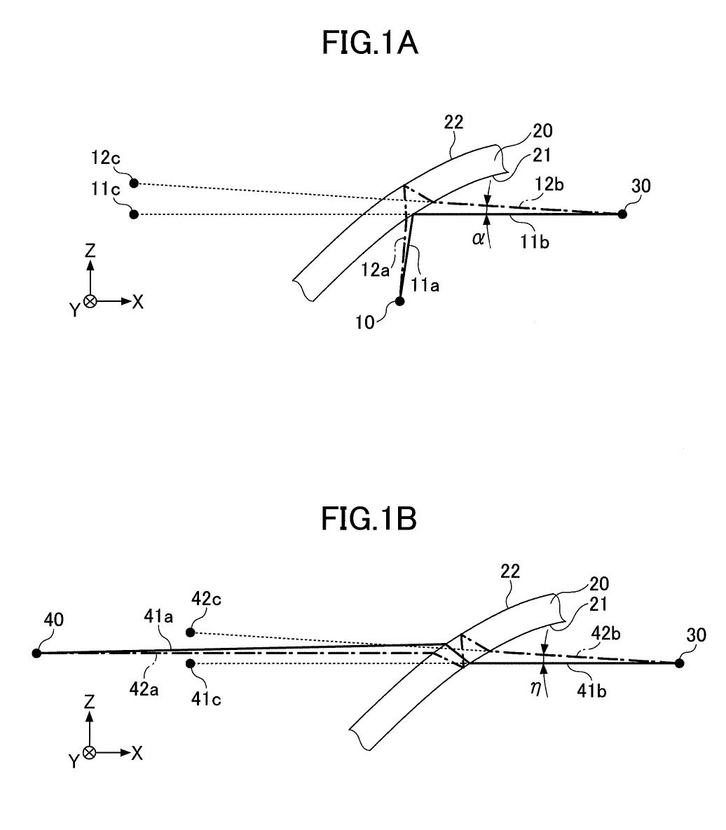

First, concepts of a reflected double image and a transmitted double image will be described. FIGS. 1A-1B diagrams illustrating concepts of double images; FIG. 1A illustrates a reflected double image, and FIG. 1B illustrates a transmitted double image. Note that in FIG. 1, X designates the forward-and-backward direction of a vehicle having a windshield 20 installed, Y designates the left-and-right direction of the vehicle, and Z designates the direction perpendicular to the XY plane (the same is assumed in the following drawings).

As illustrated in FIG. 1A, a part of rays of light 11a emitted from a light source 10 of an HUD is reflected on the inner surface 21 of the windshield 20 of the vehicle, and is brought to an eye 30 of the driver as rays of light 11b (a first beam), to be visually recognized by the driver as an image 11c (a virtual image) in front of the windshield 20.

Also, a part of rays of light 12a emitted from the light source 10 of the HUD enters the windshield 20 of the vehicle through the inner surface 21 to be refracted, and a part of these is reflected on the outer surface 22. Then, further, a part of the reflected part goes out of the windshield 20 of the vehicle through the inner surface 21 with refraction, and is brought to the eye 30 of the driver as rays of light 12b (a second beam), to be visually recognized by the driver as an image 12c (a virtual image).

These two images 11c and 12c visually recognized by the driver in this way constitute a reflected double image. Also, an angle formed by the rays of light 11b (the first beam) and the rays of light 12b (the second beam) is the angle α of the reflected double image. It is more favorable that the angle α of the reflected double image is closer to zero. In the present application, a reflected double image in the case where the second beam is seen upward as viewed from the driver is defined as a positive value.

Also, as illustrated in FIG. 1B, a part of rays of light 41a emitted from a light source 40 enters the windshield 20 of the vehicle through the outer surface 22 to be refracted, then, a part of these goes out of the windshield 20 of the vehicle through the inner surface 21 with refraction, and is brought to the eye 30 of the driver as rays of light 41b, to be visually recognized by the driver as an image 41c.

Also, a part of rays of light 42a emitted from the light source 40 enters the windshield 20 of the vehicle through the outer surface 22 to be refracted, and a part of these is reflected on the inner surface 21. Then, a part of the reflected part is further reflected on the outer surface 22, and further, a part of the twice reflected part goes out of the windshield 20 through the inner surface 21, and is brought to the eye 30 of the driver as rays of light 42b, to be visually recognized by the driver as an image 42c.

These two images 41c and 42c visually recognized by the driver in this way constitute a transmitted double image. Also, an angle formed by the rays of light 41b (the first beam) and the rays of light 42b (the second beam) is the angle η of the transmitted double image. It is more favorable that the angle η of the transmitted double image is closer to zero.

[Windshield (Laminated Glass)]

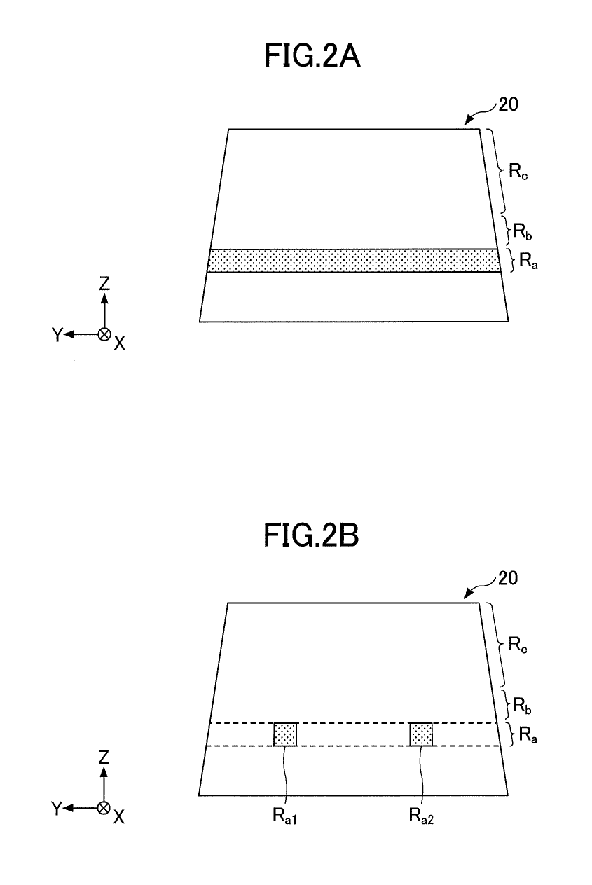

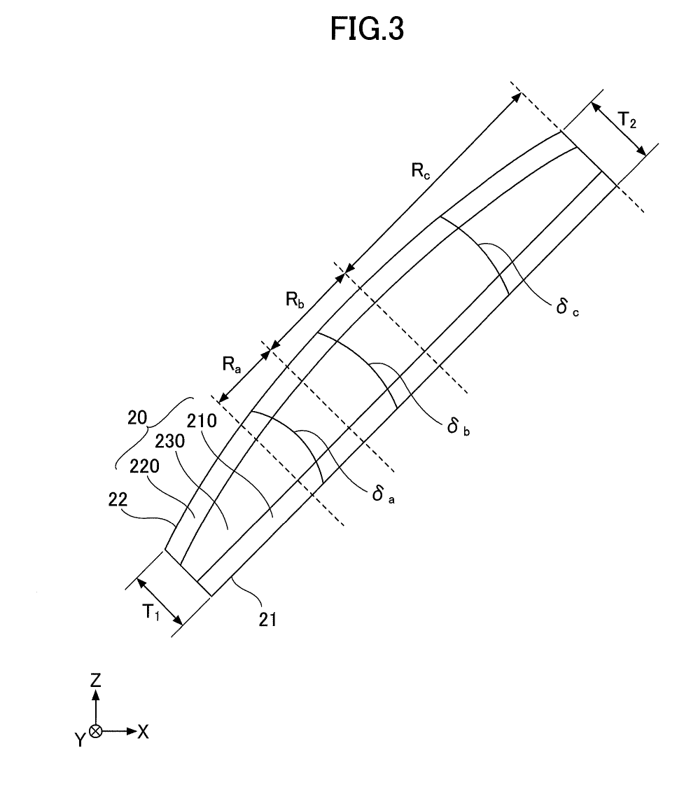

FIGS. 2A-2B are diagrams that exemplify a windshield for a vehicle, schematically illustrating the windshield viewed from the interior of the vehicle toward the exterior of the vehicle. Note that in FIGS. 2A-2B, an area used for HUD is illustrated by a satin pattern for convenience's sake.

As illustrated in FIG. 2A, the windshield 20 has a first area Rₐ used for HUD and a transition area R_{b} and a second area R_{c} not used for HUD. The transition area R_{b} and the second area R_{c} are transmission areas.

The first area Rₐ is an area on the windshield 20 on which an image (virtual image) of the HUD may be projected, which is positioned on the lower side of the windshield 20 when the windshield 20 is attached to the vehicle. Note that the first area Rₐ is a range viewed from a point V1 of JIS R3212, on which the windshield 20 is irradiated with light from a mirror constituting the HUD when the mirror constituting the HUD is rotated. In other words, when the mirror constituting the HUD is rotated to move an image on the windshield 20, there is a position at which the image on the windshield 20 disappears. This position is the boundary between the first area Rₐ used for the HUD and the other area.

The transition area R_{b} is an area extending on forward and backward sides of the maximum thickness portion of the windshield 20, by 100 mm, respectively (an area extending 100 mm both forward and backward in the vertical direction along the windshield 20), and is adjacent to the first area Rₐ in the vertical direction upward along the windshield 20. The second area R_{c} is adjacent to the transition area R_{b} in the vertical direction upward along the windshield 20, to reach the upper end of the windshield 20.

Note that the first area Rₐ may be provided, for example, entirely in the Y direction as illustrated in FIG. 2A, or may be provided partially in the Y direction. Alternatively, as illustrated in FIG. 2B, the first area Rₐ may be divided into multiple areas Rₐ₁ and Rₐ₂. In this case, the lengths of the areas Rₐ₁ and Rₐ₂ in the Y direction may not be the same, or the center positions of the areas Rₐ₁ and Rₐ₂ may be shifted in the Y direction. Also, the first area Rₐ may be divided into multiple areas spaced at predetermined intervals so as not to be in contact with each other in the vertical direction along the windshield 20.

FIG. 3 is a cross-sectional view of the windshield 20 illustrated in FIG. 2 sectioned in the XZ directions to be viewed in the Y direction. As illustrated in FIG. 3, the windshield 20 is a laminated glass that includes a glass sheet 210 as a first glass sheet, a glass sheet 220 as a second glass sheet, and an interlayer 230.

In this laminated glass, the glass sheets 210 and 220 include streaks generated by stretching in the manufacturing process. The interlayer 230 is a film that is positioned between the glass sheet 210 and the glass sheet 220, to bond the glass sheet 210 and the glass sheet 220 together, for example, such that the streaks of the glass sheet 210 and the streaks of the glass sheet 220 cross at the right angles.

The inner surface 21 of the windshield 20 as one surface of the glass sheet 210 and the outer surface 22 of the windshield 20 as one surface of the glass sheet 220 may be flat surfaces, or may be curved surfaces. The windshield 20 may have a shape, for example, curving in the vertical direction.

The first area Rₐ is formed in a wedge shape in cross-sectional view such that the thickness increases as it extends from the lower end side to the upper end side of the windshield 20 when the windshield 20 is attached to the vehicle, where δₐ represents the wedge angle. As such, a wedge angle of an area having a wedge shape in cross section where the thickness at the upper end side is thicker than the lower end side when the windshield 20 is attached to the vehicle is referred to as a positive wedge angle. In other words, the wedge angle δₐ is a positive wedge angle.

Note that the wedge angle in the present application is defined as a value obtained by dividing the difference between the thickness at the lower end and the thickness at the upper end in the vertical direction along the windshield 20, by the distance in the vertical direction along the windshield 20 in the central portion of the thickness (average wedge angle).

The reason why the first area Rₐ is formed in a positive wedge angle δₐ as a wedge shape in a cross-sectional view is to reduce reflected double images. In order to reduce reflected double images, the wedge angle δₐ is favorably set greater than or equal to +0.2 mrad. This is because if the wedge angle δₐ is less than +0.2 mrad, reflected double images cannot be reduced sufficiently.

The second area R_{c} is formed in a wedge shape in cross-sectional view such that the thickness decreases as it extends from the lower end side to the upper end side of the windshield 20 when the windshield 20 is attached to the vehicle, where δ_{c} represents the wedge angle. As such, a wedge angle of an area having a wedge shape in cross section where the thickness at the upper end side is thinner than the lower end side when the windshield 20 is attached to the vehicle is referred to as a negative wedge angle. In other words, the wedge angle δ_{c} is a negative wedge angle.

The transition area R_{b} is an area positioned between the first area Rₐ and the second area R_{c}, which includes an area formed in a wedge shape in cross-sectional view whose thickness changes gradually as it extends from the lower end side to the upper end side of the windshield 20 when the windshield 20 is attached to the vehicle, where δ_{b} represents the wedge angle.

The transition area R_{b} includes an area formed in a wedge shape in cross-sectional view whose thickness gradually increases as it extends from the lower end side toward the upper end side, and an area formed in a wedge shape in cross-sectional view whose thickness gradually decreases as it extends from the lower end side to the upper end side. In other words, the transition area R_{b} is an area in which a positive wedge angle transitions to a negative wedge angle.

The maximum thickness portion of the windshield 20 is positioned within the transition area R_{b}. In the transition area R_{b}, for example, the absolute value of the positive wedge angle gradually decreases when approaching the maximum thickness portion from the lower end side, and the absolute value of the negative wedge angle gradually increases when approaching the upper end side from the maximum thickness portion.

If areas having different wedge angles are disposed in contact with each other, a great transmission distortion occurs in an area where the wedge angle sharply changes. Providing the transition area R_{b} between the first area Rₐ and the second area R_{c} having different wedge angles, enables to gradually change the wedge angle from the first area Rₐ to the second area R_{c}. This enables to prevent transmission distortion. In order to gradually change the wedge angle from the first area Rₐ to the second area R_{c} so as to prevent transmission distortion, it is favorable to set the length of the transition area R_{b} greater than or equal to 100 mm in the vertical direction along the outer surface 22 of the windshield 20.

If areas having different wedge angles are provided in contact with each other, foaming may occur in an area where the wedge angle sharply changes. Providing the transition area R_{b} between the first area Rₐ and the second area R_{c} having different wedge angles, and gradually changing the wedge angle from the first area Rₐ to the second area R_{c}, enable to prevent occurrence of foaming.

The reason why the second area R_{c} is formed in a wedge shape in cross-sectional view with a negative wedge angle δ_{c} is to reduce the thickness at the upper end of the windshield 20. This will be described in detail as follows.

As described above, even for the same type of vehicle, there are cases where two types of windshields exist; a windshield for HUD having a wedge-shaped area in cross-sectional view, and a windshield not having a wedge-shaped area in cross-sectional view (not used for HUD). In these two types of windshields, the thickness at the upper end differs significantly. When the thickness at the upper end of the windshield differs significantly depending on the presence or absence of the wedge-shaped area in cross-sectional view, two types of attachment parts used for attaching the windshield to the vehicle frame are required, which leads to an increase of cost.

Thereupon, in the present embodiment, the second area R_{c} is formed in a wedge shape in cross-sectional view with a negative wedge angle δ_{c} so as to prevent the thickness at the upper end T₂ of the windshield 20 from increasing with respect to the thickness at the lower end T₁ of the windshield 20.

In FIG. 3, the thickness at the lower end T₁ of the windshield 20 may be set to, for example, approximately 4 mm to 5 mm. At the other end, the thickness at the upper end T₂ of the windshield 20 is favorably less than or equal to T₁+0.4 mm, and more favorably less than or equal to T₁+0.2 mm.

This is because if the thickness at the upper end T₂ of the windshield 20 is less than or equal to T₁+0.4 mm, it becomes easy to use common attachment parts with the glass not used for the HUD, whose thickness at the lower end and the upper end is T₁. This is also because if the thickness at the upper end T₂ of the windshield 20 is less than or equal to T₁+0.2 mm, it becomes further easy to use common attachment parts with the glass not used for the HUD, whose thickness at the lower end and the upper end is T₁.

However, if the absolute value of the negative wedge angle δ_{c} is set too great in order to prevent the thickness at the upper end T₂ of the windshield 20 from increasing, the transmitted double image worsen. Therefore, the wedge angle δ_{c} is favorably less than 0 mrad and greater than −1.0 mrad.

Note that preventing the thickness at the upper end T₂ of the windshield 20 from increasing is also preferable from the viewpoints of preventing the transmittance at the upper end side of the windshield 20 from decreasing, and preventing the weight of the windshield 20 from increasing.

The maximum thickness portion of the windshield 20 is favorably positioned 100 mm or more above the upper end of the first area Rₐ in the vertical direction when the windshield 20 is attached to the vehicle.

This enables to reduce the change in the wedge angle for preventing the thickness increase at the upper end with respect to the lower end of the windshield, and consequently, to prevent transmission distortion from worsening. Reducing the change in the wedge angle for preventing the thickness increase at the upper end with respect to the lower end of the windshield, also leads to prevention of occurrence of foaming. Further, occurrence of transmission distortion and foaming can be prevented in the area used for the head-up display.

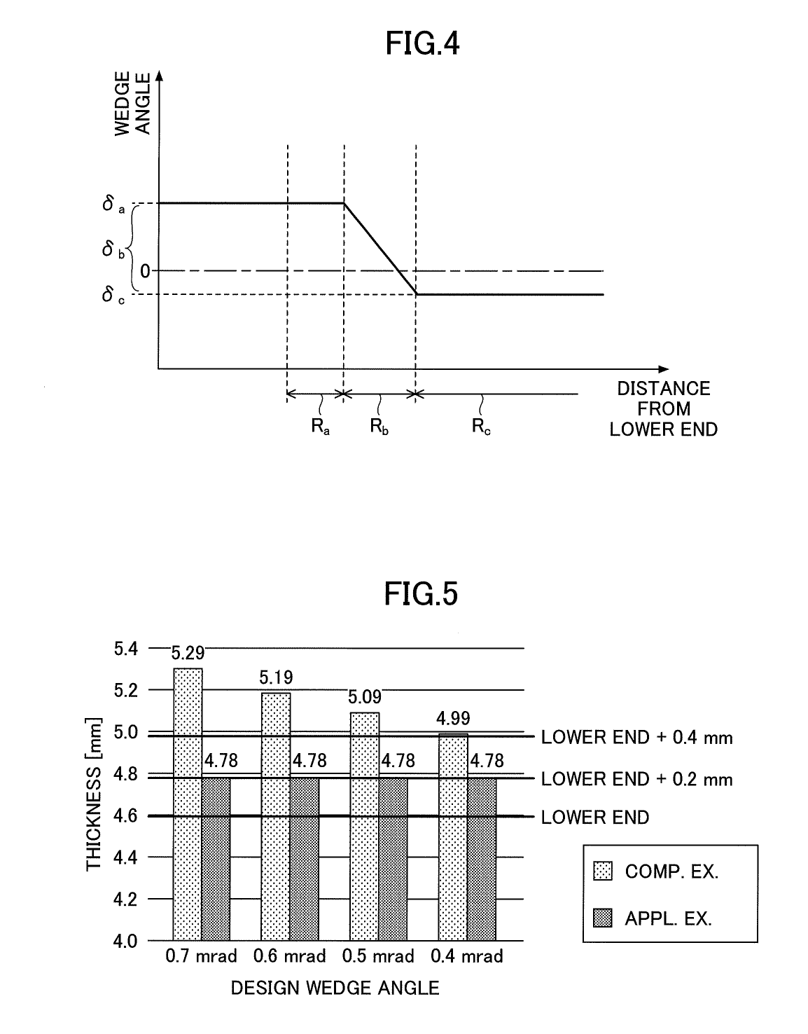

FIG. 4 is a diagram illustrating an example of the sizes of the wedge angles of the first area Rₐ, the transition area R_{b}, and the second area R_{c}. In FIG. 4, the horizontal axis represents the distance from the lower end of the windshield 20, and the vertical axis represents the wedge angle.

As illustrated in FIG. 4, the wedge angle δₐ in the first area Rₐ is positive, and the wedge angle δ_{c} in the second area R_{c} is negative. Considering the case of further dividing the transition area R_{b} into finer areas, the divided areas include an area where the wedge angle is positive, an area where the wedge angle is zero, and an area where the wedge angle is negative. In addition, in the transition area R_{b}, the positive wedge angle gradually transitions to the negative wedge angle. This enables to prevent a sharp change of the wedge angle at a portion leading to the second area R_{c} from the first area Rₐ.

Considering the case of dividing the first area Rₐ into even finer areas, although all of the divided areas are areas where the wedge angles are positive, the size of the wedge angle of each area does not need to be constant. Similarly, considering the case of dividing the second area R_{c} into even finer areas, although all of the divided areas are areas where the wedge angles are negative, the size of the wedge angle of each area does not need to be constant.

The values of the wedge angles δₐ, δ_{b}, and δ_{c} may be determined, for example, in consideration of the following points.

The JIS R3212 specifies a test area B and a test area A that is positioned further inward relative to the test area B. The standard also specifies that a transmitted double image in the test area A are within ±15 minutes and a transmitted double image in the test area B are within ±25 minutes. Therefore, the wedge angles δₐ, δ_{b}, and δ_{c} may be determined, for example, so that a transmitted double image fall within the specified ranges in the test areas A and B, and the thickness at the upper end T₂ of the windshield 20 is less than or equal to the thickness at the lower end T₁+0.4 mm (favorably, less than or equal to T₁+0.2 mm). Here, a “minute” is a unit of angle, to represent an angle of one sixtieth of one degree.

In order to make a transmitted double image in the test area A within ±15 minutes, the wedge angle δ_{c} of the second area R_{c} included in the test area A is favorably less than 0 mrad and greater than −0.7 mrad. Also, in order to make a transmitted double image in the test area B within ±25 minutes, the wedge angle δ_{c} of the second area included in the test area B is favorably less than 0 mrad and greater than −1.0 mrad.

The wedge angles of the first area Rₐ, the transition area R_{b}, and the second area R_{c} are set to any appropriate values by forming any one or two of, or all of the glass sheet 210, the glass sheet 220, and the interlayer 230 in a wedge shape(s). However, the case of forming one or both of the glass sheet 210 and the glass sheet 220 in a wedge angle(s) is more favorable compared with the case of forming the interlayer 230 in a wedge angle because change of the wedge angle over time can be prevented.

In the case of forming one or both of the glass sheet 210 and the glass sheet 220 in a wedge angle(s), conditions for manufacturing the sheets by a float glass process are engineered. In other words, by adjusting the revolving speed of multiple rolls arranged on both edges in the width direction of a glass ribbon that travels on molten metal, glass can be formed to have a concave, convex, or tapered cross section in the width direction, which may be cut to obtain a portion having a desired thickness change.

Stretching in a manufacturing process using a float glass process causes each of the glass sheets 210 and 220 to have fine stripe-shaped concavities and convexities (streaks) parallel to the traveling direction. When used as a windshield for a vehicle, if the streaks are arranged to be seen in a horizontal direction with respect to an observer's line of sight, distortion may become visually discernible, which worsens the visibility.

As the interlayer 230 that bonds the glass sheet 210 and the glass sheet 220 together, thermoplastic resin is often used, including, for example, plastic polyvinyl acetal resin, plastic polyvinyl chloride resin, saturated polyester resin, plastic saturated polyester resin, polyurethane resin, plastic polyurethane resin, ethylene acetic acid vinyl copolymer resin, and ethylene ethyl acrylate copolymer resin, which are thermoplastic resin conventionally used for this kind of application.

Among these, plastic polyvinyl acetal resin is suitably used because it has a superior balance of properties including transparency, weather resistance, strength, adhesive strength, penetration tolerance, impact energy absorption, moisture resistance, heat insulation, and acoustic insulation. The thermoplastic resin to be used may be of a single type, or may contain two or more types. Note that “plastic” in the above “plastic polyvinyl acetal resin” means having been plasticized by adding a plasticizer. This is the same for the other plastic resins.

The polyvinyl acetal resin described above may include polyvinyl formal resin obtained by having polyvinyl alcohol (may be referred to as “PVA” below if necessary) react with formaldehyde; polyvinyl acetal resin in a narrow sense obtained by having PVA react with acetaldehyde; and polyvinyl butyral resin (may be referred to as “PVB” below if necessary) obtained by having PVA react with n-butylaldehyde. Among these, PVB is suitably used because of its superior balance of properties including transparency, weather resistance, strength, adhesive strength, penetration tolerance, impact energy absorption, moisture resistance, heat insulation, and acoustic insulation. Note that the polyvinyl acetal resin to be used may be of a single type, or may contain two or more types.

The light source of the HUD is normally positioned in a lower part in the vehicle interior, from which an image is projected toward the laminated glass. Since the projection image is reflected on the front surface and the back surface of the first and second glass sheets, in order to superimpose both of the reflected images without generating double images, the thickness of the glass needs to change in parallel with the projection direction. Since the glass sheet 210 has the thickness that changes in the direction perpendicular to the streaks, in order to be used as glass on which information is projected, the streak direction needs to be perpendicular to the projection direction, namely, the streaks need to extend in the direction horizontal with the line of sight of an observer (the driver) in the vehicle interior, which means that the glass sheet 210 needs to be arranged in the direction that worsens the visibility.

In order to improve the visibility, the laminated glass manufactured by using the glass sheet 210, the glass sheet 220, and the interlayer 230 is arranged so that the streaks of the glass sheet 210 and the streaks of the glass sheet 220 are orthogonal to each other. This arrangement alleviates distortion worsened by the glass sheet 210 alone thanks to the existence of the glass sheet 220 having orthogonal streaks and of the interlayer 230 that bonds the glass sheet 210 with the glass sheet 220 together, and improves the visibility.

In the case where the glass sheets 210 and 220 are not wedged glasses, the streaks in both the glass sheets 210 and 220 are vertical with respect to the line of sight of the observer (the driver) in the vehicle interior, and hence, the visibility does not worsen.

Furthermore, laminated glass for a vehicle is normally used in a state of having a curvature shape. Shaping of the glass sheet 210 and the glass sheet 220 is generally done before bonding the glass sheets together by the interlayer 230, by heating the glass to have a temperature of approximately 550° C. to 700° C. at which the glass softens, so as to form the glass in a desired shape. The degree of curvature is referred to as “maximum curvature depth”. Here, the maximum curvature depth is the length of a perpendicular line drawn from the deepest point in the bottom of the curvature of a glass sheet that curves to have a convex shape, and is arranged so that the convex side faces downward, to a straight line connecting the middle points of a pair of facing long sides of this glass sheet, which is represented by the unit of mm.

Since the stripe-shaped fine concavities and convexities generated on the surface that cause distortion when used in laminated glass are stretched in the shaping process, a greater maximum curvature depth better improves the visibility. Although the maximum curvature depth of the glass sheet 210 and the glass sheet 220 in the present invention is not necessarily limited, it is favorably 10 mm or greater, more favorably 12 mm or greater, and even more favorably 15 mm or greater.

Note that the color of each of the glass sheets 210 and 220 is not limited in particular as long as the visible light transmittance (Tv)>70% is satisfied. Also, the glass sheet 220 as the outer sheet is favorably thicker than the glass sheet 210 as the inner sheet. Also, coating such as water repellent, anti-fogging, ultraviolet cutting/infrared cutting, and the like may be applied to the surfaces of the glass sheets 210 and 220, respectively. Also, the interlayer 230 may have an area having a sound insulating function, an infrared shielding function, an ultraviolet shielding function, a shade band (a function of lowering the visible light transmittance), and the like. Also, the windshield 20 (laminated glass) may be an anti-fogging glass.

To manufacture a laminated glass, a laminate is formed by sandwiching an interlayer 230 between a glass sheet 210 and a glass sheet 220, and then, for example, this laminate is placed in a rubber bag to be bonded in a vacuum of −65 to −100 kPa at a temperature of approximately 70 to 110° C.

Further, applying a joining treatment of heating and pressing to the laminate under conditions of, for example, 100 to 150° C. and a pressure of 0.6 to 1.3 MPa, a laminated glass having more excellent durability can be obtained. However, in some cases, this heating and pressing process may not be used to simplify the process, and in consideration of the characteristics of the materials put into the laminated glass.

FIG. 5 is a diagram illustrating design examples (application examples and comparative examples) of wedge angles. In the application examples, a windshield 20 having a lower end thickness T₁ of 4.58 mm was used. More specifically, at the lower end of the windshield 20, the thickness of the glass sheet 210 is 2 mm, the thickness of the interlayer 230 is 0.78 mm, and the thickness of the glass sheet 220 is 1.8 mm.

Then, with respect to the windshield 20, when the wedge angle of the first area Rₐ was set to a predetermined value (0.7 mrad, 0.6 mrad, 0.5 mrad, or 0.4 mrad), and the wedge angle of the second area R_{c} was set to a predetermined negative value, it was calculated whether or not the thickness at the upper end T₂ could be set to T₁+0.2 mm.

As a result, as illustrated in FIG. 5, in any of the cases where the wedge angle of the first area Rₐ is 0.7 mrad, 0.6 mrad, 0.5 mrad, or 0.4 mrad, setting the wedge angle of the second area R_{c} to the predetermined negative value achieved a thickness at the upper end T₂ of 4.78 mm (T₁+0.2 mm).

On the other hand, in the comparative examples, it was calculated whether or not the upper end thickness T₂ could be set to T₁+0.2 mm in substantially the same way as in the application examples except that the wedge angle of the second area R_{c} was set to zero or a predetermined positive value.

As a result, as illustrated in FIG. 5, in any of the cases where the wedge angles of the first area Rₐ are 0.7 mrad, 0.6 mrad, 0.5 mrad, or 0.4 mrad, setting the wedge angle of the second area R_{c} to zero or the predetermined positive value resulted in a thickness at the upper end T₂>T₁+0.4 mm; namely, the value of the thickness at the upper end T₂ cannot be contained to be less than or equal to T₁+0.4 mm.

As described above, providing the first area Rₐ that has a wedge-shaped cross-sectional shape (positive wedge angle) in which the thickness at the upper end side is thicker than at the lower end side when the windshield is attached to the vehicle; providing the second area R_{c} that has a wedge-shaped cross-sectional shape (negative wedge angle) in which the thickness at the upper end side is thinner than that at the lower end side when the windshield is attached to the vehicle; and providing the transition area R_{b} between the first area Rₐ and the second area R_{c} to prevent a sharp change in the wedge angle, enable to prevent an increase of reflected double images and transmitted double images, and to prevent an increase of the thickness at the upper end of the windshield.

As above, the preferable embodiments and the like have been described in detail. Note that the present invention is not limited to the embodiments and the like described above, which may be changed and replaced in various ways without departing from the scope described in the claims.

1. A laminated glass comprising:
a first glass sheet;
a second glass sheet; and
an interlayer positioned between the first glass sheet and the second glass sheet, to bond the first glass sheet and the second glass sheet together,
wherein a first area, a transition area, and a second area are provided from a lower side of the laminated glass when the laminated glass is attached to a vehicle,
wherein the first area is used for a head-up display, and the transition area and the second area are not used for the head-up display,
wherein the first area has a thickness at an upper end side thicker than at lower end side when the laminated glass is attached to the vehicle, to have a wedge-shaped cross-sectional shape forming a positive wedge angle,
wherein the second area has a thickness at an upper end side thinner than at lower end side when the laminated glass is attached to the vehicle, to have a wedge-shaped cross-sectional shape forming a negative wedge angle, and
wherein the transition area is an area in which the positive wedge angle transitions to the negative wedge angle.

2. The laminated glass as claimed in claim 1, wherein a maximum thickness portion of the laminated glass is positioned within the transition area.

3. The laminated glass as claimed in claim 1, wherein a maximum thickness portion of the laminated glass is positioned 100 mm or more above the upper end of the first area in a vertical direction when the laminated glass is attached to the vehicle.

4. The laminated glass as claimed in claim 1, wherein the wedge angle of the second area is less than 0 mrad and greater than −1.0 mrad.

5. The laminated glass as claimed in claim 4, wherein the wedge angle of the second area included in a test area A specified in JIS R3212 is less than 0 mrad and greater than −0.7 mrad.

6. The laminated glass as claimed in claim 4, wherein the wedge angle of the second area included in a test area B specified in JIS R3212 is less than 0 mrad and greater than −1.0 mrad.

7. The laminated glass as claimed in claim 1, wherein the wedge angle of the first area is greater than or equal to +0.2 mrad.

8. The laminated glass as claimed in claim 1, wherein a thickness of an upper end when the laminated glass is attached to the vehicle is less than or equal to a thickness at the lower end plus 0.4 mm.

9. The laminated glass as claimed in claim 8, wherein the thickness at the upper end when the laminated glass is attached to the vehicle is less than or equal to the thickness at the lower end plus 0.2 mm.

10. The laminated glass as claimed in claim 1, wherein a length of the transition area in a vertical direction along the laminated glass is greater than or equal to 100 mm.
